(19) United States
(12) Patent Application Publication
(10) Pub. No.: US 2021/0208610 A1
(43) Pub. Date: Jul. 8, 2021

(54) UNMANNED AERIAL VEHICLE TRACKING PROCESSING METHOD AND CONTROL TERMINAL

(71) Applicant: SZ DJI TECHNOLOGY CO., LTD., Shenzhen (CN)

(72) Inventors: Chao WENG, Shenzhen (CN); Hongjing CHEN, Shenzhen (CN)

(21) Appl. No.: 17/033,333

(22) Filed: Sep. 25, 2020

Related U.S. Application Data
(63) Continuation of application No. PCT/CN2018/080442, filed on Mar. 26, 2018.

(51) Int. Cl. G05D 1/12; G05D 1/10; G05D 1/00; H04N 5/33; G06F 3/0481; G06F 3/0488

(52) U.S. Cl. CPC G05D 1/12; G05D 1/101; G05D 1/0094; G06F 3/0488; H04N 5/33; G06F 3/04817; G05D 1/0016

(57) ABSTRACT

A tracking method includes receiving a start-tracking instruction, determining a tracking target through thermal tracking according to the start-tracking instruction, and marking the tracking target at a preset position of a display interface.

### CROSS-REFERENCE TO RELATED APPLICATION

This application is a continuation of International Application No. PCT/CN2018/080442, filed Mar. 26, 2018, the entire content of which is incorporated herein by reference.

### TECHNICAL FIELD

The present disclosure generally relates to the unmanned aerial vehicle (UAV) technology field and, more particularly, to a UAV tracking processing method and a control terminal.

### BACKGROUND

With the development of the unmanned aerial vehicle (UAV) technology, UAV is widely used in various areas. An important function of the UAV includes tracking a specific target. A user may track the target using a control terminal to control the UAV. Under the control of the control terminal, the UAV may detect a tracking target through a specific method and adjust a flight direction of the UAV according to a position of the tracking target, so as to continuously track the tracking target. During tracking, the user may also perform an operation, such as changing a tracking target, stopping tracking, etc., at an interface of the control terminal.

In the existing technology, the tracking operation, which is performed by the user at the control terminal, is complex. Therefore, a simple and user-friendly operation needs to be provided to simplify the user's operation and improve user experience.

### SUMMARY

Embodiments of the present disclosure provide a tracking method. The method includes receiving a start-tracking instruction, determining a tracking target through thermal tracking according to the start-tracking instruction, and marking the tracking target at a preset position of a display interface.

Embodiments of the present disclosure provide a control terminal includes a processor and a memory. The memory stores a program instruction that, when executed by the processor, causes the processor to receive a start-tracking instruction, determine a tracking target through thermal tracking according to the start-tracking instruction, and mark the tracking target at a preset position of a display interface.

Embodiments of the present disclosure provide a computer-readable storage medium. The computer-readable storage medium stores a computer program that, when executed by a processor of a control terminal, causes the control terminal to receive a start-tracking instruction, determine a tracking target through thermal tracking according to the start-tracking instruction, and mark the tracking target at a preset position of a display interface.

### BRIEF DESCRIPTION OF THE DRAWINGS

FIG. 1 is a schematic structural diagram of a system for implementing an unmanned aerial vehicle (UAV) tracking processing method according to some embodiments of the present disclosure.

FIG. 2 is a schematic flowchart of the UAV tracking processing method according to some embodiments of the present disclosure.

FIG. 3 is a schematic diagram showing an interaction between a user and a first control component according to some embodiments of the present disclosure.

FIG. 4 is a schematic diagram showing an interaction that the user uses a second control component to start tracking a target and stop tracking the target in the UAV tracking processing method according to some embodiments of the present disclosure.

FIG. 5 is a schematic flowchart of a UAV tracking processing method according to some other embodiments of the present disclosure.

FIG. 6 is a schematic diagram showing an interface for switching tracking targets according to some embodiments of the present disclosure.

FIG. 7 is a schematic flowchart of a UAV tracking processing method according to some other embodiments of the present disclosure.

FIG. 8 is a schematic block diagram showing a control terminal according to some embodiments of the present disclosure.

### DETAILED DESCRIPTION OF THE EMBODIMENTS

To make purposes, technical solutions, and advantages of the present disclosure clearer, the technical solutions in embodiments of the present disclosure are described in conjunction with accompanying drawings in embodiments of the present disclosure. The described embodiments are only some embodiments not all the embodiments of the present disclosure. Based on the embodiments of the disclosure, all other embodiments obtained by those of ordinary skill in the art without any creative work are within the scope of the present disclosure.

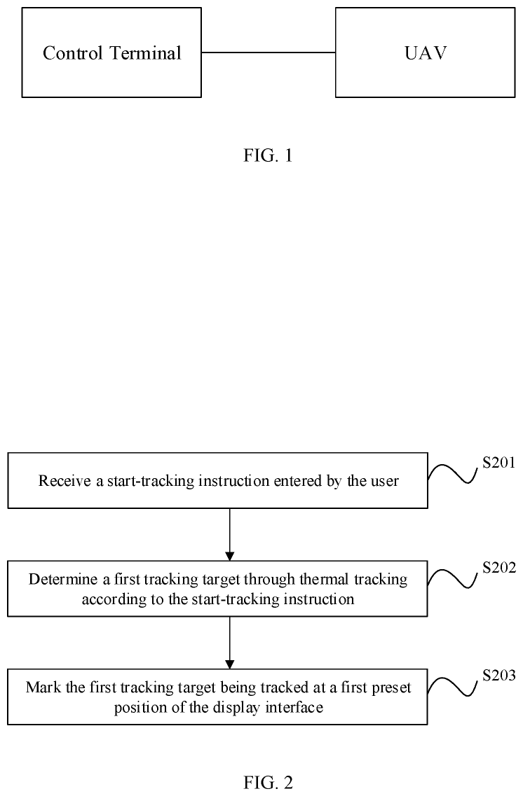

FIG. 1 is a schematic structural diagram of a system for implementing an unmanned aerial vehicle (UAV) tracking processing method according to some embodiments of the present disclosure. As shown in FIG. 1, the method relates to a control terminal and a UAV. The control terminal may provide an operable interface for a user to enter an operation instruction, convert the operation instruction from the user into a UAV control instruction, and send the UAV control instruction to the UAV. The control terminal may also receive information returned by the UAV and display information that needs to be displayed to the user. The control terminal may include a cell phone, a tablet, a laptop computer, etc. In some embodiments, for example, the UAV may perform target tracking according to an instruction from the control terminal. In some embodiments, the UAV may continuously change the position of the UAV by detecting the position of the target to realize continuous tracking. Further, a camera may be carried by a gimbal of the UAV and be configured to capture an image of a target being tracked and send the image to the control terminal for display. When the position of the target is changed, an angle of the gimbal may be adjusted in time to ensure that the target to be always displayed at the center of the image.

FIG. 2 is a schematic flowchart of the UAV tracking processing method according to some embodiments of the present disclosure. As shown in FIG. 2, the method includes the following processes.

At S201, a start-tracking instruction entered by the user is received.

At S202, a first tracking target is determined through thermal tracking according to the start-tracking instruction.

The start-tracking instruction is used to instruct the control terminal to start a tracking function.

In some embodiments, the control terminal may display a first control component, for example, a control button. The user may click this control component to start the tracking function. After the tracking function is started, the control terminal may display a second icon configured to start tracking a specific target or stop tracking. A specific interaction manner is described in detail in following embodiments.

In some embodiments, after starting the tracking function, the control terminal may send the instruction to the UAV to cause the UAV to determine the first tracking target by the thermal tracking. In the thermal tracking process, an infrared detection may be performed on the surrounding of the UAV to obtain an infrared code stream, and a hottest point of a current image in the infrared code stream is used as the tracking target. The thermal tracking method has high sensitivity and a broad tracking range. By applying the thermal tracking to the UAV to track the target, the UAV may be ensured to perform the target tracking quickly and accurately under different flight statuses.

At S203, the first tracking target being tracked is marked at a first preset position of the display interface.

When continuously performing the target tracking through the thermal tracking, the UAV may return the current image captured by the camera back to the control terminal. In some embodiments, the UAV may further send the position of the first tracking target being tracked in the image to the control terminal simultaneously. The UAV may adjust the angle of the gimbal in time according to the position of the first tracking target being tracked to ensure the first tracking target to be always located at the first preset position of the image.

In some embodiments, the first preset position may be a center position of the image.

After receiving the current image, the control terminal may display a mark at the position of the first tracking target at the display interface, for example, a circular point, or a square block, etc., to mark the position, where the first tracking target is currently located, for the user.

In some embodiments, when a distance between the display position of the first tracking target and the first preset position is larger than a preset value, the control terminal may re-display the first tracking target at the first preset position, i.e., moving the first tracking target to the first preset position.

In some embodiments, the control terminal may control the UAV to perform the target tracking according to the start-tracking instruction entered by the user. Further, after obtaining the image of the tracking target being tracked, the control terminal may mark the tracking target in the display image, such that it is convenient for the user to operate. In addition, the user may quickly view the tracking target without other operations. Therefore, the user experience is greatly improved. Further, the thermal tracking is used to perform the target tracking, such that the UAV may quickly and accurately perform the target tracking under different flight statuses.

In following embodiments, interaction with the interface and processing method during the interaction are described in detail.

In embodiments of the present disclosure, the image currently captured by the UAV may be displayed at the display interface in real-time.

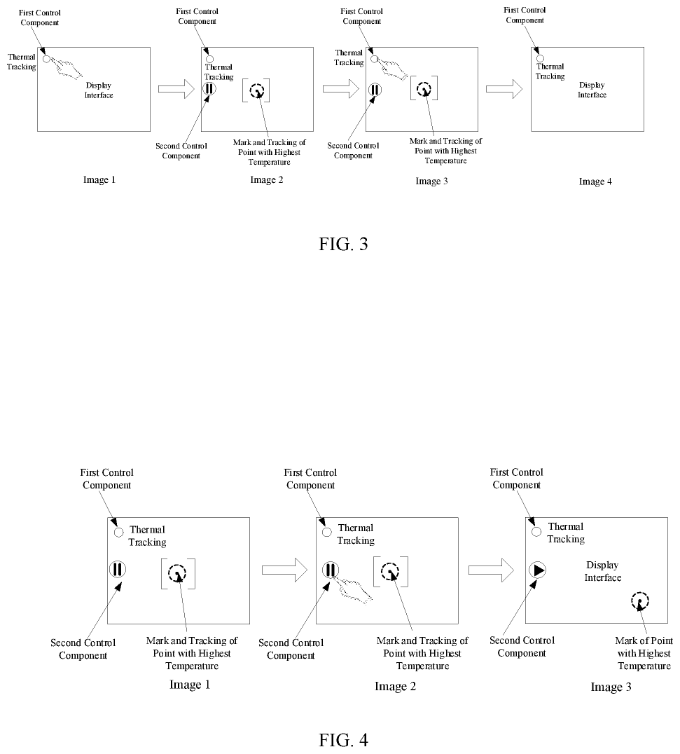

FIG. 3 is a schematic diagram showing the interaction between a user and a first control component according to some embodiments of the present disclosure. As shown in FIG. 3, the interaction with the interface includes the following processes.

After the user initially logs into a tracking interface, image (1) is displayed, that is, the first control component is displayed at the upper left corner of the interface. After the user clicks the first control component, the tracking function is started, and the image changes to image (2), that is, the second control component is displayed at the center position at the left edge of the interface. An icon of the second control component is a first icon, for example, a pause icon. If the user clicks the second control component, a specific target tracking is triggered. The interaction after the user clicks the second control component is described as follows. In some embodiments, in image (2), the control terminal marks a point with a highest temperature at the display interface and performs the target tracking automatically, that is, the control terminal marks the point with the highest temperature at the currently captured image and performs the target tracking automatically. Further, in image (3) of FIG. 2, when the first control component is clicked again, the UAV exits the tracking function, and the image changes to image (4). In image (4), only the first control component is displayed, and the second control component is no longer displayed.

The operation corresponding to image (3), that is, after starting the tracking function, the user clicks the first control component again, may happen at any time after the tracking function is started. That is, the user may click the first control component again to turn off the tracking function at any time after the tracking function is started.

The processing process of the control terminal during the interaction with the interface includes the following processes.

The first control component may include two statuses of a start status and a stop status. Initially, the first control component is in the stop status. After the user clicks the first control component in image (1), the tracking function is started, and the first control component changes to the start status. After the user clicks the first control component again in image (3), the tracking function is turned off, and the first control component changes to the stop status. Only when the first control component is in the start status, the second control component may be displayed. Therefore, the user may operate the second control component to perform the specific target tracking, tracking target switching, etc. When the first control component is in the stop status, the tracking function may be turned off, and the control terminal may not display the second control component, mark the point with the highest temperature of the image, and perform the target tracking.

In some embodiments, as shown in image (1), the control terminal displays the first control component at a displayed second preset position and detects whether the user performs a touch operation on the first control component. If the control terminal detects that the user performs the touch operation on the first control component, and the first control component is in the stop status, the control terminal receives the start-tracking instruction of the user. Further, the control terminal adjusts the first control component to be in the start status. Further, as shown in image (2), the control terminal displays the second control component at a third preset position of the display interface. Further, as shown in image (3), the control terminal detects whether the user performs the touch operation on the first control component. If the control terminal detects that the user performs the touch operation on the first control component, and the first control component is in the start status, the tracking is stopped, the second control component is hidden, and the first control component is adjusted to be in the stop status.

In some embodiments, the tracking function may be started and turned off through the first control component. When the first control component is in the start status, the second control component is configured for the user to perform a specific tracking control operation. Therefore, the operation is simple, function division is clear, and the interaction is user-friendly.

FIG. 4 is a schematic diagram showing interaction that the user uses the second control component to start tracking a target and stop tracking the target according to some embodiments of the present disclosure. As shown in FIG. 4, the interaction with the interface includes the following processes.

After the user clicks the first control component to start the tracking function, in image (1), the second control component is displayed. The icon of the second control component is the first icon, that is, a pause icon. The control terminal marks the point with the highest temperature in image (1) and uses the point with the highest temperature as the tracking target to perform the target tracking automatically. Further, in image (2), the user clicks the second control component again, and the image changes to image (3). The icon of the second control component changes from the first icon to a second icon, that is, from the pause icon to a start icon, the target tracking for the point with the highest temperature is stopped simultaneously, and only the point with the highest temperature is marked. If the user re-clicks the second control component in image (3), the image changes to image (1) again to continue with the interaction.

The processing process of the control terminal in the above-described interaction may include the following.

The second control component may include two statuses of a tracking status and a pause status. The second control component may include different display icons under different statuses. In some embodiments, the pause icon may be displayed in the tracking status. The start icon may be displayed in the pause status. Initially, the second control component is in the pause status. When image (1) is shown, the second control component changes to the tracking status automatically, and the icon of the second control component changes to the pause icon. When image (3) is shown, the second control component changes to the pause status automatically, the icon of the second control component changes to the start icon.

In some embodiments, when the control terminal detects that the user performs the touch operation on the second control component, and the second control component is in the pause status, the control terminal tracks the first tracking target, adjusts the status of the second control component to the tracking status, and adjusts the display icon of the second control component to the first icon (i.e., the pause icon).

When the control terminal detects that the user performs the touch operation on the second control component, and the second control component is in the tracking status, the tracking is stopped. The control terminal further adjusts the status of the second control component to the pause status and adjusts the display icon of the second control component to the second icon (i.e., the start icon).

Besides adjusting the status of the second control component to the pause status through detecting the touch operation, the status of the second control component may also be adjusted to the pause status in the following scenarios.

If no tracking target is found in a preset time, and the second control component is in the tracking status, the tracking may be stopped, the status of the second control component may be adjusted to the pause status, and the display icon of the second control component may be adjusted to the second icon (i.e., the start icon).

In some embodiments, because different icons are set for the same second control component under different statuses, the user may perform specific tracking control through the same icon. Therefore, the operation is simple, and the interaction is user-friendly.

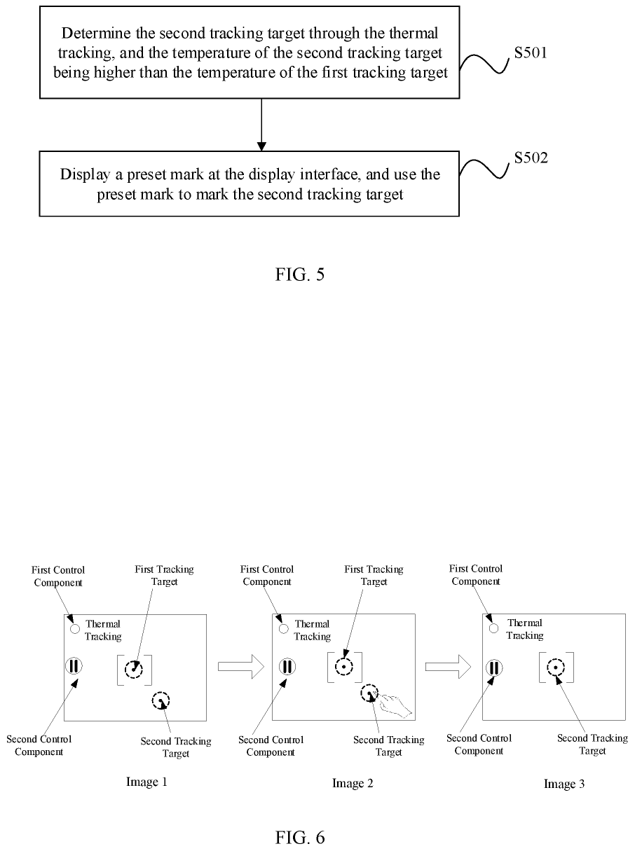

FIG. 5 is a schematic flowchart of the UAV tracking processing method according to some other embodiments of the present disclosure. The method includes the following processes.

At S501, the second tracking target is determined through the thermal tracking, and the temperature of the second tracking target is higher than the temperature of the first tracking target.

At S502, a preset mark is displayed at the display interface, and the preset mark is used to mark the second tracking target.

In some embodiments, when performing the target tracking with the display interface being one shown in image (1) of FIG. 4, the UAV may continuously detect the first tracking target being tracked and the surrounding temperature of the first tracking target. When a point is detected to have a higher temperature than the first tracking target, that is, when the point currently has the highest temperature, the point may be used as the second tracking target, and the preset mark may be added to the second tracking target in the display interface.

FIG. 6 is a schematic diagram showing an interface for switching tracking targets according to some embodiments of the present disclosure. In some embodiments, as shown in image (1) of FIG. 6, the UAV is currently tracking the first tracking target, which is marked in image (1). When the UAV detects that the second tracking target currently has the highest temperature, the second tracking target is marked in the interface. A marking manner for the second tracking target can be different from that for the first tracking target, such that the user may view the first tracking target and the second tracking target conveniently. For example, in some embodiments, the tracking target being currently tracked may be marked using a block frame, and the second tracking target may be marked using a circle with a dotted line.

Further, when the mark of the second tracking target appears in the image, the user may choose to switch to the second tacking target to perform the target tracking.

In some embodiments, the user may switch the tracking targets by continuously clicking the second control component. Each time after the second control component is changed from the pause status to the tracking status, the control terminal may control the UAV to re-select the point with the current highest temperature to perform the target tracking. Therefore, if the first tracking target is currently tracked, and the temperature of the second tracking target is higher than the temperature of the first tracking target, the user may first click the second control component once, the second control component may be in the pause status after clicking, and the UAV may not track any of the targets. Then, the user may click the second control component again once, then the second control component may enter the tracking status after the clicking. Meanwhile, the UAV may select the point with the current highest temperature to perform the target tracking. Since the second tracking target has the highest temperature, the UAV may track the second tracking target, that is, the tracking target may be switched from the first tracking target to the second tracking target. The processing process after each clicking may refer to the interaction of the second control component, which is not repeated here.

In other embodiments, the user may also switch the tracking target by clicking the mark of the second tracking target.

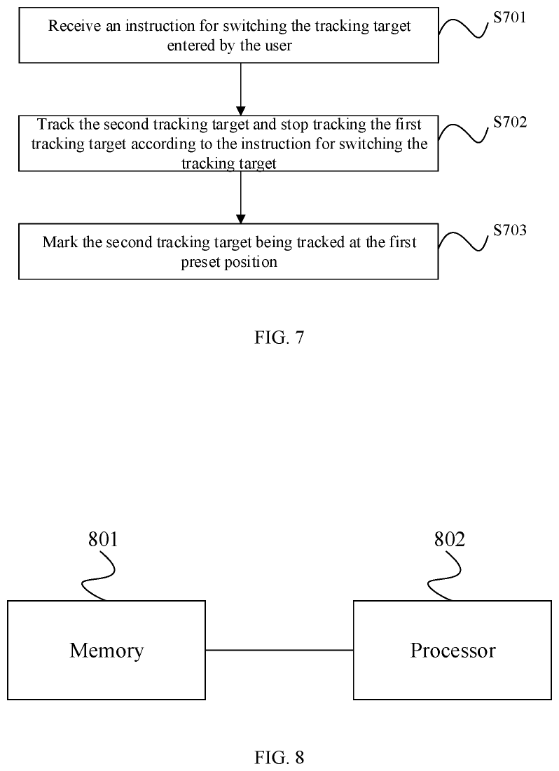

FIG. 7 is a schematic flowchart of the UAV tracking processing method according to some other embodiments of the present disclosure. As shown in FIG. 7, after the second tracking target is marked in the display interface, the method further includes the following processes.

At S701, an instruction for switching the tracking target entered by the user is received.

In some embodiments, the control terminal may determine whether the user performs the touch operation at the position where the preset mark is located in the display interface. If yes, the instruction for switching the tracking target entered by the user is received. The instruction for switching the tracking target is also referred to as a “target switching instruction.”

As shown in image (2) of FIG. 6, in the interface, the user may click the mark corresponding to the second tracking target, then the control terminal may receive the instruction for switching the tracking target.

At S702, the UAV tracks the second tracking target and stops tracking the first tracking target according to the instruction for switching the tracking target.

At S703, the second tracking target being tracked is marked at the first preset position.

In some embodiments, the control terminal may instruct the UAV to stop tracking the first tracking target and switch to track the second tracking target according to the instruction for switching the tracking target. After switching the tracking target, the UAV may adjust the angle of the image to display the second tracking target currently being tracked at the first preset position and mark the second tracking target at the first preset position. As such, the target being tracked may be ensured to be at the same position of the image.

For example, in the interface as shown in image (3) of FIG. 6, after the tracking of the first tracking target is stopped, the first tracking target is not marked in the image anymore. Then, the second tracking target is marked according to the marking manner when the first tracking target is tracked, and the second tracking target is displayed in the center position of the image.

FIG. 8 is a schematic block diagram showing a control terminal according to some embodiments of the present disclosure. As shown in FIG. 8, the control terminal includes a memory 801 and a processor 802. The memory 801 stores program instructions that, when executed by the processor 802, cause the processor 802 to receive a start-tracking instruction entered by a user, determine a first tracking target through thermal tracking according to the start-tracking instruction, and mark the first tracking target being tracked at a first preset position of a display interface.

The processor 802 is further caused to display a first control component at a second preset position of the display interface, and if the control terminal detects that the user performs a touch operation on the first control component, and the first control component is in a stop status, receive the start-tracking instruction.

The processor 802 is further caused to adjust the status of the first control component to a start status.

The processor 802 is further caused to display a second control component at a third preset position of the display interface.

The processor 802 is further caused to adjust the status of the second control component to a tracking status, and adjust the display icon of the second control component to a first icon.

The processor 802 is further caused to determine a second tracking target through the thermal tracking, the temperature of the second tracking target being higher than the temperature of the first tracking target, and display the preset mark on the display interface, the preset mark being configured to mark the second tracking target.

The processor 802 is further caused to receive the instruction for switching the tracking target entered by the user, track the second tracking target and stop tracking the first tracking target according to the instruction for switching the tracking target, and mark the second tracking target being tracked at the first preset position.

The processor 802 is further caused to determine whether the user performs the touch operation at the position where the preset mark is located in the display interface, and if yes, receive the instruction for switching the tracking target.

The processor 802 is further caused to, if the control terminal detects that the user performs the touch operation on the second control component, and the second control component is in the tracking status, stop tracking, adjust the status of the second control component to the pause status, and adjust the display icon of the second control component to the second icon.

The processor 802 is further caused to, if the tracking target is not found in a preset time, and the status of the second control component is the tracking status, stop tracking, adjust the status of the second control component to the pause status, and adjust the display icon of the second control component to the second icon.

The processor 802 is further caused to, if the control terminal detects that the user performs the touch operation on the second control component, and the status of the second control component is the pause status, track the first tracking target, adjust the status of the second control component to the tracking status, and adjust the display icon of the second control component to the first icon.

The processor 802 is further caused to, if the control terminal detects that the user performs the touch operation on the second control component, and the status of the second control component is the start status, stop tracking, hide the second control component, and adjust the status of the first control component to the stop status.

The processor 802 is further caused to, if a distance between a display position of the first tracking target and the first preset position is longer than a preset value, move the first tracking target to the first preset position.

Those of ordinary skill in the art should understand that all or a part of the processes for realizing embodiments of the present disclosure may be implemented through hardware related to the program instruction. The program may be stored in a computer-readable storage medium. When the program is executed, the processor is caused to execute the processes of method embodiments of the present disclosure. The storage medium may include various media that can store program codes, such as read-only memory (ROM), random access memory (RAM), magnetic disks, or optical disks, etc.

Finally, the above embodiments are only used to illustrate the technical solutions of the present disclosure, but not to limit them. Although the present disclosure is described in detail with reference to the foregoing embodiments, those of ordinary skill in the art should understand that modifications may be made to the technical solutions of the foregoing embodiments, or equivalent replacements may be made to some or all of the technical features, and these modifications or replacements do not make the essence of the corresponding technical solutions depart from the scope of the technical solutions of embodiments of the present disclosure.

What is claimed is:

1. A tracking method comprising:
receiving a start-tracking instruction;
determining a tracking target through thermal tracking according to the start-tracking instruction; and
marking the tracking target at a preset position of a display interface.

2. The method of claim 1, wherein:
the preset position is a first preset position; and
receiving the start-tracking instruction includes:
displaying a control component at a second preset position of the display interface; and
in response to detecting a touch operation on the control component and a status of the control component being a stop status, receiving the start-tracking instruction.

3. The method of claim 2, further comprising:
adjusting the status of the control component to a start status.

4. The method of claim 3,
wherein the control component is a first control component;
the method further comprising:
displaying a second control component at a third preset position of the display interface.

5. The method of claim 4, further comprising:
adjusting a status of the second control component to a tracking status.

6. The method of claim 3,
wherein the tracking target is a first tracking target;
the method further comprising:
determining a second tracking target through thermal tracking, a temperature of the second tracking target being higher than a temperature of the first tracking target; and
displaying a preset mark in the display interface to mark the second tracking target.

7. The method of the claim 6, further comprising:
receiving a target switching instruction;
tracking the second tracking target and stopping tracking the first tracking target according to the target switching instruction; and
marking the second tracking target at the first preset position.

8. The method of claim 7, wherein receiving the target switching instruction includes:
determining whether a touch operation is performed on a position where the preset mark is located in the display interface; and
in response to the touch operation being performed, receiving the target switching instruction.

9. The method of claim 3,
wherein the control component is a first control component;
the method further comprising:
in response to detecting a touch operation performed on a second control component and a status of the second control component being a tracking status, stopping tracking, adjusting the status of the second control component to a pause status, and changing a display icon of the second control component.

10. The method of claim 9,
wherein:
the display icon of the second control component is a first icon before being changed; and
changing the display icon of the second control component includes changing the display icon of the second control component from the first icon to a second icon;
the method further comprising:
in response to detecting another touch operation performed on the second control component and the status of the second control component being the pause status, tracking the tracking target, adjusting the status of the second control component to the tracking status, and adjusting the display icon of the second control component from the second icon to the first icon.

11. The method of claim 3,
wherein the control component is a first control component;
the method further comprising:
in response to not detecting a tracking target in a preset time and a status of a second control component being a tracking status, stopping tracking, adjusting the status of the second control component to a pause status, and changing a display icon of the second control component.

12. The method of claim 11,
wherein:
the display icon of the second control component is a first icon before being changed; and
changing the display icon of the second control component includes changing the display icon of the second control component from the first icon to a second icon;
the method further comprising:
in response to detecting a touch operation performed on the second control component and the status of the second control component being the pause status, tracking the tracking target, adjusting the status of the second control component to the tracking status, and adjusting the display icon of the second control component from the second icon to the first icon.

13. The method of claim 3,
wherein the control component is a first control component;
the method further comprising:
in response to detecting a touch operation performed on the first control component and the status of the first control component being the start status, stopping tracking, hiding a second control component, and adjusting the status of the first control component to a stop status.

14. The method of claim 1, further comprising:
in response to a distance between a display position of the tracking target and the preset position being longer than a preset value, moving the tracking target to the preset position.

15. A control terminal comprising:
a processor; and
a memory storing program instructions that, when executed by the processor, cause the processor to:
receive a start-tracking instruction;
determine a tracking target through thermal tracking according to the start-tracking instruction; and
mark the tracking target at a preset position of a display interface.

16. The method of claim 15, wherein:
the preset position is a first preset position; and
receiving the start-tracking instruction includes:
displaying a control component at a second preset position of the display interface; and
in response to detecting a touch operation on the control component and a status of the control component being a stop status, receiving the start-tracking instruction.

17. The method of claim 16, further comprising:
adjusting the status of the control component to a start status.

18. The method of claim 17,
wherein the tracking target is a first tracking target;
the method further comprising:
determining a second tracking target through thermal tracking, a temperature of the second tracking target being higher than a temperature of the first tracking target; and
displaying a preset mark in the display interface to mark the second tracking target.

19. A computer-readable storage medium storing a computer program that, when executed by a processor of a control terminal, causes the control terminal to:
receive a start-tracking instruction;
determine a tracking target through thermal tracking according to the start-tracking instruction; and
mark the tracking target at a preset position of a display interface.
